(19) United States
(12) Patent Application Publication
(10) Pub. No.: US 2026/0313342 A1
(43) Pub. Date: Oct. 8, 2026

(54) METHOD AND DEVICE FOR SUPPORTING WARNING MESSAGE

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 19/483,381

(22) PCT Filed: May 12, 2023
(86) PCT No.: PCT/CN2023/094044

§ 371 Date: Nov. 11, 2025

(51) Int. Cl. H04W 4/90; H04W 8/00; H04W 88/04; H04W 92/18

(52) U.S. Cl. CPC H04W 4/90; H04W 8/005; H04W 88/04; H04W 92/18

(57) ABSTRACT

The present disclosure provides a method for avoiding the reception of duplicated warning messages in a wireless communication system. This method is performed by a UE-to-Network (U2N) relay and includes receiving a warning message from a network, determining whether the received warning message is a duplicated message, and dropping the warning message if it is determined to be a duplicated message. The present disclosure enhances the efficiency of warning systems by preventing the delivery of duplicated messages.

### CROSS-REFERENCE TO RELATED APPLICATIONS

The present disclosure is a U.S. national phase of PCT Application No. PCT/CN2023/094044 filed on May 12, 2023, the content of which is hereby incorporated by reference in its entirety.

### TECHNICAL FIELD

The present disclosure relates to the field of wireless communication. More specifically, the present disclosure pertains to a method for avoiding the reception of duplicated warning messages in a UE-to-Network (U2N) relay system.

### BACKGROUND

With the increasing use of wireless communication systems, warning messages are often broadcast to alert users of potential hazards or important events.

### SUMMARY

In a first aspect, the present disclosure provides a method for avoiding duplicated warning messages, performed by a U2N relay. The method comprises: receiving a warning message from a network, and determining whether the warning message (e.g., a received Public Warning System (PWS) message) is a duplicated message.

In a second aspect, the present disclosure provides a U2N relay comprising means for carrying out the method as described previously.

In a third aspect, the present disclosure provides a non-transitory computer-readable medium comprising instructions that, when executed by a U2N relay, cause the U2N relay to carry out the method as described previously.

In a fourth aspect, the present disclosure provides a system. The system comprises a U2N relay configured to perform the method, a UE configured to receive the warning message transmitted by the U2N relay, and a network device configured to transmit the warning message to the U2N relay.

### BRIEF DESCRIPTION OF DRAWINGS

In the following, the present disclosure is described in more detail with reference to the accompanying figures.

FIG. 1 a flow diagram of the method for avoiding the reception of duplicated message,

FIG. 2 an embodiment according to the present disclosure, and

FIG. 3 a UE-to-Network relay or a UE.

### DETAILED DESCRIPTION

With the increasing use of wireless communication systems, warning messages are often broadcast to alert users of potential hazards or important events. However, the current U2N relay systems have an issue where they can receive and deliver duplicated warning messages. This can lead to confusion and unnecessary use of resources. A solution to suppress these duplicated messages is required to improve the efficiency of the warning system.

The present disclosure proposes a method for avoiding duplicated warning messages, ensuring an efficient, robust, and reliable warning message transmission.

A warning message or public warning message (e.g., as Public Warning System, PWS, message), in the context of the present disclosure and more generally within the field of telecommunications, refers to an alert or notification disseminated via a communication network to inform the public or specific groups of users about potential, imminent, or ongoing emergencies, hazards, or threats.

These messages serve a critical role in public safety, enabling timely dissemination of important alerts and instructions to help people protect themselves and others during emergencies.

In the context of the present disclosure, the 5G ProSe UE-to-Network relay may receive such warning messages from the network and broadcast them to the 5G ProSe Remote UEs using the procedures and mechanisms specified. This ensures that even in situations where certain UEs may not have a direct connection to the network, they can still receive critical warning messages in a timely manner.

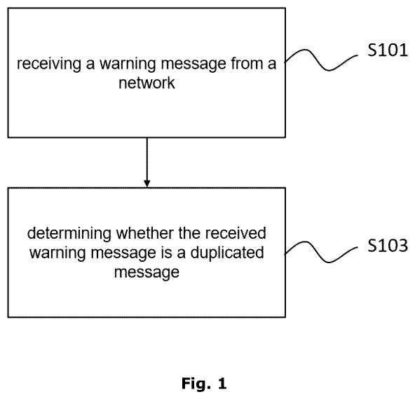

FIG. 1 shows a flow diagram of the proposed method. The method for avoiding duplicated warning messages performed by a U2N relay includes the steps:
S101: receiving a warning message from a network;
S103: determining whether the received warning message is a duplicated message.

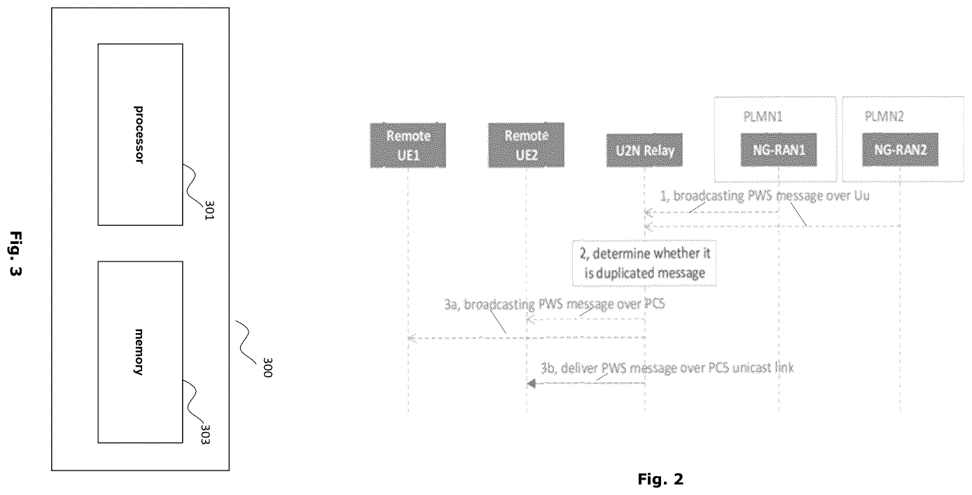

FIG. 2 shows a detailed embodiment according to the present disclosure.

Step 1: In this step, one or more Next Generation Radio Access Network (NG-RAN) of a Public Land Mobile Network (PLMN) broadcasts the Public Warning System (PWS) message(s) over Uu in System Information Block (SIB). NG-RAN is a component of the mobile telecommunication system that communicates wirelessly with user equipment (UE), such as mobile phones. The PLMN is a network established and operated by a mobile operator to provide mobile telecommunications services to the public. The Uu interface is the air interface between the UE and the NG-RAN. The PWS messages may be broadcast as part of the SIB, which is a set of data transmitted over the Uu interface providing essential information required by the UE to access and use the services of the network. This step is crucial in ensuring that the UEs are aware of any imminent hazards or important events.

Step 2: In this step, the U2N relay may receive the PWS message(s) broadcasted over the Uu interface. The U2N relay is a device that acts as an intermediary between the network and the UE. Upon receiving the PWS message, the U2N relay interprets the message to determine whether it is a duplicated message. This determination can be based on various factors, such as the unique identifier associated with the PWS message. If the U2N relay determines that the received PWS message is a duplicated message, it drops the message. This step is key to preventing the delivery of duplicate PWS messages to the UE, which can cause confusion and waste network resources.
Step 3a: In this step, after determining that the received PWS message is not a duplicated message, the U2N relay may broadcast the PWS message over the Proximity Services (PC5) interface, for instance, via a U2N direct discovery procedure. The PC5 interface allows direct communication between UEs, including U2N relays, without needing to route the communication through the core network. This broadcasting can reach multiple UEs within a certain range. This step is important as it allows the efficient and rapid dissemination of the PWS message to multiple UEs. In the context of the present disclosure, the UEs are also known as remote UEs. In this case, a 5G ProSe (Proximity Services) Remote UE is a device that relies on the 5G ProSe UE-to-Network (U2N) relay to receive information from and send information to the main 5G network. The relay acts as an intermediary, forwarding or broadcasting information between the network and the Remote UEs. This setup can be particularly useful in situations where the Remote UEs are out of direct range of the main network or in areas with limited network coverage.

Remote UEs might include devices such as smartphones, tablets, laptops, or any other devices that are equipped to operate within a 5G network and utilize ProSe services. In the context of the present disclosure, the Remote UEs are capable of receiving warning messages broadcasted by the 5G ProSe U2N relay, which can be critical for public safety and emergency response scenarios.

Step 3b: In this step, the U2N relay may send the PWS message to a remote UE via a PC5 unicast link when the remote UE is connected to the U2N relay. A unicast link is a one-to-one link, so this transmission is specifically targeted at the remote UE. This step ensures that the PWS message reaches the intended UE when it is connected to the U2N relay. This is especially beneficial in scenarios where the remote UE is not within the range of the initial PWS broadcast or when a more targeted delivery is required.

Reference is now made to FIG. 3, which shows a simplified block diagram of an example embodiment of a UE-to-Network relay 300 according to the present disclosure. Preferably, the U2N relay is also a UE. Device 300 includes a processor 301 and a memory storage device 303. The memory storage device 303 may store a computer program or application containing instructions that, when executed, cause the processor 301 to perform operations such as those described herein. For example, the instructions may handle public warning message broadcasting and receiving in accordance with the methods described herein. It will be understood that the instructions may be stored on a non-transitory computer-readable medium, such as a compact disc, flash memory device, random access memory, hard drive, etc. When the instructions are executed, processor 301 carries out the operations and functions specified in the instructions so as to operate as a special-purpose processor that implements the described process(es). Such a processor may be referred to as a “processor circuit” or “processor circuitry” in some examples.

The disclosed methods and embodiments provide efficient handling of warning massage in a 5G Proximity Services (ProSe) UE-to-Network relay system, ensuring timely assistance to remote UEs while avoiding resource waste and unnecessary delays.

In a first aspect, the present disclosure provides a method for avoiding duplicated warning messages, performed by a U2N relay. The method comprises receiving a warning message from a network, preferably the warning message is broadcasted over Uu by one or more Next Generation Radio Access Network (NG-RAN) of Public Land Mobile Network (PLMN), and determining whether the received PWS message is a duplicated message. Preferably, the warning message is a Public Warning System (PWS) message. This step of the method ensures that no duplicated messages are delivered, thereby reducing redundancy and saving network resources.

Preferably, the present disclosure comprises broadcasting the warning message over a Proximity Services (PC5) link after determining that the received warning message is not a duplicated message. If the message is determined to be duplicated, the U2N relay drops the received warning message (i.e., the received message being ignored and the U2N relay does not take any action on it). Therefore, the duplicated message may be disregarded and may not be subjected to any further transmission. The use of the PC5 link in broadcasting ensures that the message is delivered to all necessary devices within a certain proximity, thus increasing the reach of the warning message.

Preferably, the present disclosure further comprises transmitting the warning message to a remote User Equipment (UE) via a PC5 unicast link when the remote UE is connected to the U2N relay, after determining that the received warning message is not a duplicated message. This allows for targeted delivery of the message to a specific UE when it is connected to the U2N relay, thereby ensuring that necessary warning messages are received by the intended UE.

Preferably, the broadcasting of the PWS message is executed via a U2N direct discovery procedure. This allows for a more efficient delivery of the warning message. For example, the PWS message may be included in a UE-to-Network relay discovery announcement message and/or a relay discovery additional information message. By employing these specific types of messages, the present disclosure ensures an efficient, robust, and reliable warning message, in particular, a public warning message broadcasting system, thereby enhancing safety and awareness in the network.

Preferably, the determining step includes analyzing a unique identifier associated with the warning message. The unique identifier may be a sequence number or a timestamp associated with the warning message. This allows for a precise and fast determination of whether a received message is duplicated.

Preferably, the duplicated warning message is defined as a message having identical content and being received within a predefined time window. This provides a clear and strict definition of what constitutes a duplicated message.

The present disclosure also includes a U2N relay configured to carry out the method as described above, a computer program, and a computer-readable medium comprising instructions for executing the method, and a system comprising a U2N relay, a UE, and a network device for implementing the above-described methods.

In another aspect of the present disclosure, the U2N relay comprises means for carrying out the method as described previously. This means the U2N relay is equipped with the necessary hardware and software components, such as processors, memory, and may be communication interfaces, to receive, analyze, drop or broadcast/transmit the PWS messages.

In the computer program aspect of the present disclosure, the program includes instructions which, when executed by a U2N relay, cause the U2N relay to carry out the method as described in the previous claims. This set of instructions can be implemented as software or firmware and stored on a non-transitory computer-readable medium.

In a system aspect of the present disclosure, the system comprises a U2N relay configured to perform the method, a UE configured to receive the warning message transmitted by the U2N relay, and a network device configured to transmit the warning message to the U2N relay. The interconnectedness of these devices ensures that the warning messages are transmitted, received, and analyzed appropriately, thereby increasing the effectiveness of public warning systems.

Certain adaptations and modifications of the described embodiments can be made. Therefore, the above-discussed embodiments are considered to be illustrative and not restrictive. In particular, embodiments can be freely combined with each other.

1. A method for avoiding duplicated warning messages, performed by a UE-to-Network (U2N) relay, the method comprising:
receiving a warning message from a network; and
determining whether the warning message is a duplicated message.

2. The method of claim 1, further comprising:
broadcasting the warning message over Proximity Services (PC5) link after determining that the warning message is not a duplicated message; and
dropping the warning message if the warning message is determined to be a duplicated message.

3. The method of claim 1, further comprising:
transmitting the warning message to a remote User Equipment (UE) via a PC5 unicast link when the remote UE is connected to the U2N relay, after determining that the warning message is not a duplicated message.

4. The method of claim 2, wherein the broadcasting of the warning message is executed via a U2N direct discovery procedure.

5. The method of claim 1, wherein determining whether the warning message is the duplicated message includes analyzing a unique identifier associated with the warning message.

6. The method of claim 5, wherein the unique identifier is a sequence number or timestamp associated with the warning message.

7. The method of claim 1, wherein the duplicated warning message is defined as a message having content and being received within a predefined time window.

8. A UE-to-Network (U2N) relay, configured to:
receive a warning message from a network; and
determine whether the warning message is a duplicated message.

9. (canceled)

10. A non-transitory computer-readable medium comprising instructions which, when executed by a UE-to-Network (U2N) relay, cause the U2N relay to carry out the method of claim 1.

11. A system comprising:
a UE-to-Network (U2N) relay, configured to receive a warning message from a network and to determine whether the warning message is a duplicated message; a User Equipment (UE) configured to receive the Public Warning System (PWS) message transmitted by the U2N relay; and
a network device configured to transmit the warning message to the U2N relay.

12. A communication device, comprising: a memory; and a processor, connected to the memory, configured to, by executing computer-executable instructions stored on the memory, control the communication device to perform the method of claim 1.

13. The U2N relay of claim 8, further configured to:
broadcast the warning message over Proximity Services (PC5) link after determining that the warning message is not a duplicated message; and
drop the warning message if the warning message is determined to be a duplicated message.

14. The U2N relay of claim 8, further configured to:
transmit the warning message to a remote User Equipment (UE) via a PC5 unicast link when the remote UE is connected to the U2N relay, after determining that the warning message is not a duplicated message.

15. The U2N relay of claim 13, wherein the broadcasting of the warning message is executed via a U2N direct discovery procedure.

16. The U2N relay of claim 8, wherein the determining step includes analyzing a unique identifier associated with the warning message.

17. The U2N relay of claim 16, wherein the unique identifier is a sequence number or timestamp associated with the warning message.

18. The U2N relay of claim 8, wherein the duplicated message is defined as a message having content and being received within a predefined time window.

19. The system of claim 11, wherein the U2N relay is further configured to:
broadcast the warning message over Proximity Services (PC5) link after determining that the warning message is not a duplicated message; and
drop the warning message if the warning message is determined to be a duplicated message.

20. The system of claim 11, wherein the U2N relay is further configured to:
transmit the warning message to a remote UE via a PC5 unicast link when the remote UE is connected to the U2N relay, after determining that the warning message is not a duplicated message.

21. The system of claim 20, wherein the broadcasting of the warning message is executed via a U2N direct discovery procedure.
